(19) United States
(12) Patent Application Publication
(10) Pub. No.: US 2015/0165368 A1
(43) Pub. Date: Jun. 18, 2015

(54) UTILIZATION OF HEAT FOR THE SEPARATION OF CO2

(71) Applicant: Siemens Aktiengesellschaft, Munich (DE)

(72) Inventors: Christian Brunhuber, Auerbach (DE); Hermann Kremer, Liederbach (DE); Mike Rost, Burgthann (DE); Rudiger Schneider, Eppstein (DE); Henning Schramm, Frankfurt am Main (DE); Nicolas Vortmeyer, Erlangen (DE); Gerhard Zimmermann, Hochstadt/Aisch (DE)

(73) Assignee: Siemens Aktiengesellschaft, Munich (DE)

(21) Appl. No.: 14/417,155

(22) PCT Filed: Jun. 19, 2013
(86) PCT No.: PCT/EP2013/062731

§ 371 Date: Jan. 25, 2015

(30) Foreign Application Priority Data
Jul. 31, 2012 (EP) 12178656.0

(51) Int. Cl. B01D 53/14; F23J 15/00

(52) U.S. Cl. CPC B01D 53/1425; B01D 53/1475; F23J 15/006

(57) ABSTRACT

A device for separating CO2 from an exhaust gas flow of a combustion device is provided. The device has a store for storing a heat transfer fluid together with a CO₂ separating device which has an absorber and a desorber. The store and the desorber are thermally coupled to each other via a line system, and the store is thermally coupled to an electrically driven heating device which allows a thermal conditioning of the heat transfer fluid in the store. The heating device is designed as a gas turbine driven by a generator as a motor, and air is sucked into the compression stage of the gas turbine while the turbine is driven and is substantially adiabatically heated as a result of the compression. The heated exhaust gas exiting the gas turbine interacts with the store for the purpose of the heat transfer.

### CROSS REFERENCE TO RELATED APPLICATIONS

This application is the US National Stage of International Application No. PCT/EP2013/062731 filed Jun. 19, 2013, and claims the benefit thereof. The International Application claims the benefit of European Application No. EP12178656 filed Jul. 31, 2012. All of the applications are incorporated by reference herein in their entirety.

### FIELD OF INVENTION

The present invention relates to a device for separating CO₂ from a flue gas of a combustion device and also to a method for operating such a device.

### BACKGROUND OF INVENTION

The separation of CO₂ from the flue gas of a fossil-fired power plant or a fossil-fired industrial plant has gained great importance not only with regard to the emissions trade agreements which have been implemented by a large number of countries. Moreover, over recent years regulations have been adopted, particularly also in the European Union, which directly target CO₂ separation technology. For example, reference is to be made in this case to the European CCS directive from the year 2009 of the European Union already implemented in a large number of European states, which in the years up to 2020 requires the new construction of highly efficient power plants by application of CCS technology. Other non-European states follow comparable legal approaches.

For separating CO₂ from the flue gas of a fossil-fired power plant, multiple solutions have already been proposed. To be counted among these is the Post-Cap technology developed by the applicant which enables a subsequent separation of the CO₂from the flue gas with regard to the combustion process. The separating apparatus in question provides the targeted treatment of the flue gas by means of an aqueous solution of amino acid salts as scrubbing agent (solvent) which enable a selective binding of the CO₂. In a desorber of this apparatus, the complex of amino acid salts and CO₂ is broken up again after thermal treatment so that the released CO₂ can be separated out in gaseous form. The solvent which is re-acquired during this process can be fed to an absorber for a repeated CO₂ separation. Details of this technology are described for example in patent application DE 10 2010 013 729.4 of the applicant.

The separation of CO₂ from a flue gas flow by means of this technology requires on the one hand electric energy, for example in order to operate the pumps, compressors and additional electric consumer units which are incorporated in the CO₂ separating device, and also thermal energy which is required for the regeneration of the solvent in the desorber. According to the prior art, the heat which is fed to the desorber is typically extracted from the process steam of a power plant or an industrial engineering combustion plant. Therefore, the thermal energy for the processes maintained by the process steam, which is fed to the desorber, is lost, however. An undesirable reduced level of efficiency results especially in the case of power generation by means of a steam process which is supported by the process steam.

In order to ensure an alternative supply of the desorber with inexpensive heat, EP2425887A1 proposes to generate the necessary thermal energy with an array of solar collectors, the heat of which can also be stored for a short time in a thermal accumulator.

Furthermore, it proves to be disadvantageous, however, that a supply of the desorber by means of process steam can only be carried out at times at which sufficient process steam is available, for example in the case of the subject matter of EP2425887A1 when sufficient sunshine prevails. Since within the scope of the reorganization of the nationwide energy supply in some countries a number of power plants are operated only intermittently or are subjected to severe fluctuations of the demanded power plant output, the provision of process steam can sometimes be ensured only at a temporally fluctuating level.

Furthermore, it is disadvantageous that during startup of a power plant still insufficient quantities of heat can sometimes be fed to the desorber in order to ensure an efficient operation of the CO₂ separating apparatus.

Therefore, it proves to be technically necessary to propose a suitable device for separating CO₂ from a flue gas flow of a combustion device which by and large can avoid the disadvantages from the prior art. In particular, it is the object of the present invention to propose a device which enables an energy-efficient separation of CO₂ from a flue gas flow. In addition, a device for the separation of CO₂ is to be proposed, the operational readiness of which device is subjected to lower temporal fluctuations, or not just determined solely by the operating state of the combustion device. More particularly, a technical solution is also to be able to use already existing energy infrastructure so that the consequence is low initial investments for provisioning.

### SUMMARY OF INVENTION

According to embodiments of the invention, this object is achieved by means of a device for separating CO₂ from a flue gas flow of a combustion device according to an independent claim, and also by means of a method for operating such a device according to another independent claim.

In particular, an object upon which the invention is based is achieved by means of a device for separating CO₂ from a flue gas flow of a combustion device, which device in addition to a CO₂ separating apparatus having an absorber and a desorber has an accumulator for storing a heat transfer fluid, wherein the accumulator and the desorber are thermally interconnected via a piping system, and wherein the accumulator is thermally connected to an electrically operated heating device which enables a thermal conditioning of the heat transfer fluid in the accumulator, wherein the heating device is designed as a gas turbine driven by a generator as a motor, during the driving of which air is drawn into the compression stage of the gas turbine and as a result of the compression is essentially adiabatically heated, and wherein the heated flue gas discharging from the gas turbine interacts with the accumulator for transfer of heat.

Furthermore, another object upon which the invention is based is achieved by means of a method for operating a device for separating CO₂ from a flue gas flow of a combustion device, which in addition to a CO₂ separating apparatus having an absorber and a desorber has an accumulator for storing a heat transfer fluid, wherein the accumulator and the desorber are thermally interconnected, and wherein the accumulator is connected to an electrically operated heating device which is designed as a gas turbine driven by a generator as a motor, during the driving of which air is drawn into the compression stage of the gas turbine and as a result of the compression is essentially adiabatically heated, which method features the following steps:

Operating the heating device using electric power, wherein the heated flue gas discharging from the gas turbine interacts with the accumulator for heating the heat transfer fluid in the accumulator;

Heating a solvent of the CO₂ separating apparatus, which is laden with CO₂ and fed to the desorber, by means of the heated heat transfer fluid.

According to the invention, it is consequently provided that the device for the separation of CO₂, in addition to a CO₂ separating apparatus having an absorber and a desorber, additionally has an accumulator in which heat transfer fluid can be stored. The accumulator is connected to an electrically operated heating device which allows a thermal conditioning of the heat transfer fluid in the accumulator. According to the invention, the heat transfer fluid contained in the accumulator can therefore be heated to an extent that it achieves a desired temperature level. After achieving this temperature level, the heat transfer fluid can be fed via the piping system to the desorber of the CO₂ separating apparatus, wherein the heat which is stored in the heat transfer fluid is at least partially transferred to the desorber.

According to the invention, the supply of the desorber with heat with the aid of the accumulator can be decoupled from the operation of the combustion device at least to the extent that the desorber can also be supplied with heat when the combustion device itself is not operated or operated only in a low load state. Consequently, it is possible, for example, that the accumulator which is filled with the heat transfer fluid is supplied with sufficient quantities of thermal energy during operation of the combustion device in order to still supply the desorber with sufficient heat via the accumulator even after shutting down of the combustion device or after a change of the load state. Particularly during startup of the combustion device, sufficient heat can therefore be fed to the desorber via the accumulator in order to be able to ensure an efficient operation of the CO₂ separating apparatus.

Furthermore, it proves to be advantageous to then store heat with the aid of the heat transfer fluid contained in the accumulator if sufficient electric power, especially in the public electricity supply networks, is available for storage. Therefore, it is advantageous, for example, at times of availability of excess current in the public electricity supply networks to use this for generating heat which can then be stored in the accumulator with the aid of the heat transfer fluid. The thermal energy which is temporarily stored in the accumulator in this way can be extracted again at a later point in time, for example if more current demand than current availability prevails in the public electricity supply networks, in order to therefore operate the desorber in an energy-efficient manner. In particular, the total supply of the desorber by means of process steam can then be dispensed with, wherein at least some of the heat can be extracted from the accumulator.

On account of the electric operation of the heating device, a technically comparatively simple solution is realized, moreover, in which the electric current is quickly converted into another, easily storable form of energy. On account of the electric operation of the heating device, moreover, fluctuations of the electric current availability can also be reacted to without any problem.

The heating device is designed as a gas turbine driven by a generator as a motor, the flue gas of which gas turbine interacts with the accumulator for transfer of heat. According to an embodiment of the invention, the demanded electric energy is therefore used for operating the generator as a motor so that the gas turbine which is mechanically connected thereto executes an enforced rotational movement. During this operation of the gas turbine, air is drawn into the compression stage of the gas turbine and compressed, wherein an essentially adiabatic heating of the compressed air is the result. The flue gas discharging from the gas turbine, which is heated appreciably in comparison to the drawn-in air, is fed to the accumulator so that after a suitable transfer of heat the heat transfer fluid contained in the accumulator is heated. Depending on the rotational speed of the gas turbine which is operated by the generator as a motor, temperatures of the flue gas up to about 200° C. can thus be achieved (without additional firing by means of combusting fuel in the gas turbine). The use of the gas turbine as a heating device is particularly advantageous especially on account of the good availability of gas turbines. The gas turbines need to be only slightly adapted for such an operation so that a suitable heating device can already be made available with only low investment costs as well. According to a first especially preferred embodiment of the device according to an embodiment of the invention, it is provided that the air heating can be additionally supported by means of a suitable firing of the gas turbine.

According to the embodiment, it is also possible that the piping system has an expansion vessel which is designed for separating expanded heat transfer fluid into a condensed phase and into a gaseous phase. Such an expansion vessel, which is also referred to as a “flash vessel”, especially allows pressurized, superheated liquids to be expanded to a lower pressure, wherein the expanded heat transfer fluid can be separated into two different phases which are essentially in thermal equilibrium. Accordingly, it is also especially preferred if the heat transfer fluid in the accumulator is pressurized and superheated so that even comparatively large quantities of thermal energy can be stored therein. In addition, heat at a comparatively high temperature level is therefore also available for the desorber of the CO₂ separating apparatus.

The use of an expansion vessel proves to be especially advantageous if the piping system has an expansion valve which is connected upstream to the expansion vessel. The expansion valve in this case ensures a targeted and controlled expansion of the heat transfer fluid.

It also proves to be advantageous if the piping system has a first heat exchanger which is designed for an exchange of heat between the heat transfer fluid which is fed to the expansion vessel and the gaseous heat transfer fluid which is discharged from the expansion vessel. The gaseous heat transfer fluid in this case enables some of the thermal energy of the heat transfer fluid which is fed to the expansion vessel to be absorbed for superheating purposes in order to increase its heat content. As a result, it can be ensured that the gaseous heat transfer fluid which is discharged from the accumulator is not already condensed in the piping system 40 before, for example, it can release some of its thermal energy in a reboiler heat exchanger 25.

According to a further embodiment, it is also conceivable that the piping system has a second heat exchanger which is designed for an exchange of heat between the gaseous heat transfer fluid which is discharged from the expansion vessel and the CO₂-laden solvent of the CO₂ separating apparatus which is fed to the desorber. The second heat exchanger allows a targeted heat input from the flow of the gaseous heat transfer fluid into the desorber. The second heat exchanger 80 is preferably designed as a reboiler heat exchanger 25.

According to a further embodiment, it is also conceivable that the piping system opens into the desorber and delivers heat transfer medium into this. Consequently, a direct exchange of heat is possible between heat transfer fluid and the solvent which is contained in the CO₂ separating apparatus. In this case, it is necessary, however, that in a subsequent process step the heat transfer fluid is recovered again. In such a case, the transfer fluid is typically water which is introduced into the desorber, wherein the water mixes with the solvent contained therein. In a further process step, for example the condensing out of this water which is introduced in this way can then be carried out and also the return into a utilization circuit.

According to the embodiment, it can also be provided that the piping system is of a cyclic design so that after thermal interaction of the heat transfer fluid with the desorber this can be returned to the accumulator again. Such a cyclic piping system is not only economical in material and maintenance friendly but also energy efficient. On account of the return of the heat transfer fluid into the accumulator, the residual heat which is inherent in the heat transfer fluid can be recovered and utilized again.

According to a further embodiment of the invention, it is provided that the piping system is designed in such a way that the condensed phase of the expanded heat transfer fluid can be returned to the accumulator again. Therefore, a maintenance-friendly, resource-economizing and energy-efficient solution can again be provided.

According to another embodiment of the invention, it is provided that the accumulator is a pressure accumulator. Consequently, a significantly higher heat content in comparison to an open accumulator can be transferred to the heat transfer fluid contained in the accumulator and can subsequently be available for utilization in the desorber. In addition, it is also possible, on account of the pressure accumulation, to minimize the heat losses in comparison to an open system. A pressure accumulator in conjunction with water as heat transfer fluid is especially advantageous. Other heat transfer fluids with a higher boiling point can also be provided as an alternative, however. These can also be stored in the accumulator under ambient pressure or under increased pressure in comparison to this.

According to another embodiment of the invention, it is provided that the heat transfer fluid is water. This is not only inexpensive in its provision but also easily technically manageable.

According to a further embodiment of the method according to the invention, it is provided that the heating device is operated using electric excess current. With this, a particularly efficient operation of the heating device can be ensured since the consumed excess current can be extracted comparatively inexpensively or even gainfully from the public electricity supply networks. The method according to the embodiment, moreover, enables a suitable consumer unit to be made available which can be used as a control unit when excess current in the public electricity supply networks is available.

According to a further embodiment of the method, it can also be provided that a step is also included for the thermal expansion of the heated heat transfer fluid in an expansion vessel before the heat transfer fluid heats the solvent of the CO₂ separating apparatus which is laden with CO₂ and fed to the desorber. As already explained further above, the expansion of the heated heat transfer fluid in the expansion vessel allows a separation into a gaseous and into a liquid phase and therefore an advantageous thermal conditioning thereof.

Furthermore, according to another embodiment of the method, it can be provided that for supporting the heating of the compressed air in the compression stage of the gas turbine this can be additionally fired.

Further embodiments are gathered from the dependent claims.

### BRIEF DESCRIPTION OF THE DRAWINGS

Embodiments of the inventive idea shall be explained in more detail below with reference to figures. In this case, reference may be made to the fact that the schematic nature of the figures does not signify any limitation with regard to the substantiation of the subject matter of the embodiments of the invention.

Furthermore, reference may be made to the fact the features shown in the figures are claimed both on their own as well in conjunction with the features which are covered by other embodiments.

In the drawing, in this case:

FIG. 1 shows a first embodiment of the CO₂ separating apparatus according to the invention in a schematic view of connections;

FIG. 2 shows an embodiment of the device according to the invention for separating CO₂ from a flue gas flow in a schematic partial view;

FIG. 3 shows an embodiment, not claimed in the present case, of a device for the separation of CO₂ in a schematic view of connections;

FIG. 4 shows an embodiment, not claimed in the present case, of a device for the separation of CO₂ in a schematic view of connections.

### DETAILED DESCRIPTION OF INVENTION

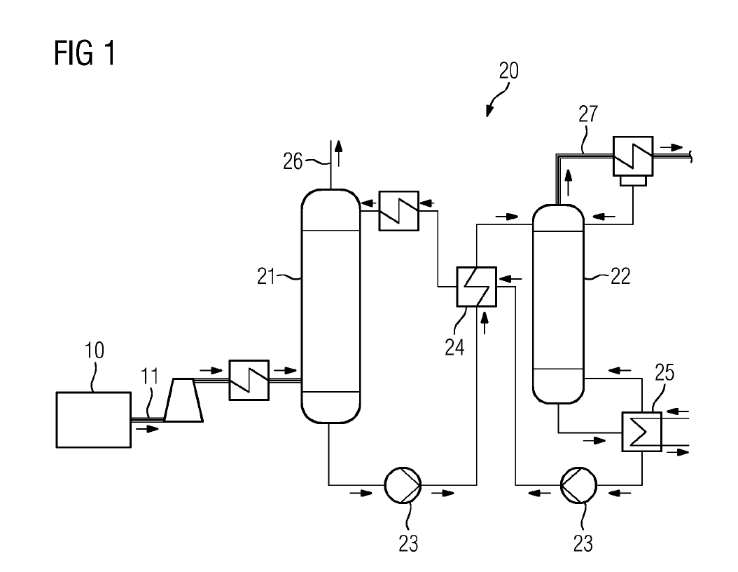

FIG. 1 shows an embodiment of a CO₂ separating apparatus 20 as can be incorporated in a device 1 for separating CO₂ from a flue gas flow 11 of a combustion device 10. The CO₂ separating apparatus 20 has an absorber 21 and a desorber 22 which both interact for separating CO₂ from the flue gas flow 11. In this case, the flue gas flow 11 discharging from the combustion device 10 is first fed to the absorber 21 in which in the flue gas flow the CO₂ which is present is for the large part bound by scrubbing with a solvent (scrubbing agent). The cleaned flue gas discharges from a discharge pipe 26 for possible further utilization or cleaning. The flue gas can also be discharged into the free environment without further utilization. The separated CO₂ is combined with the solvent, forming a complex, and accumulates at the bottom end of the absorber 21. The CO₂-laden solvent is fed by means of a pump 23 to the desorber 22 in which the CO₂ is again separated from the solvent by thermal treatment. For this purpose, the CO₂-laden solvent is sprayed into the desorber 22, wherein the released CO₂ can be discharged through a CO₂ outlet pipe 27 at the top end of the desorber 22. The solvent which accumulates at the bottom end of the desorber 22 is fed to a reboiler heat exchanger 25 which supplies the solvent with sufficient thermal energy in order to be able to promote the splitting of CO₂ from the solvent. In this case, the solvent is especially evaporated and fed again to the desorber 22. At the same time, the heat which is essential for the recovery of the CO₂-impoverished solvent (regenerated solvent) is therefore fed to the desorber 22. The regenerated solvent which is available after this heat treatment is again fed by means of a pump to the absorber 21 for CO₂ separation. In order to improve the heat balance between absorber 21 and desorber 22, a heat exchanger is also provided between the flow of CO₂-laden solvent discharging from the absorber 21 and the flow of regenerated solvent discharging from the desorber 22.

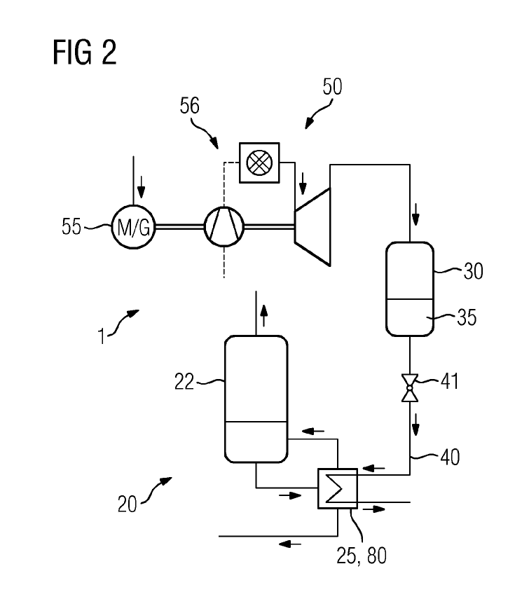

FIG. 2 shows a schematic partial view of a further embodiment of the device 1 according to the invention for separating CO₂ from a flue gas flow 11 of a combustion device 10 (not shown in the present case). Only the desorber 22, which is connected via a piping system 40 to an accumulator 30, is shown in the figure. The accumulator 30 in this case contains a predetermined quantity of heat transfer fluid 35 which can be fed via the piping system 40 in a directed manner to a reboiler heat exchanger 25 or to a second heat exchanger 80. The reboiler heat exchanger 25 or the second heat exchanger 80 allows an input of heat into the desorber 22 via suitable piping sections. In this case, the heat contained in the heat transfer fluid 35 is transferred via the reboiler heat exchanger 25 or the second heat exchanger 80 to the solvent contained in the desorber 22. As a result of the transfer of heat, a separation of the CO₂ from the laden solvent is carried out. In order to advantageously adjust the quantity of heat transfer fluid 35 which is fed to the reboiler heat exchanger 25 or to the second heat exchanger 80, a valve 41 or a suitable means of adjustment in general is provided in the piping system 40. The heat contained in the heat transfer fluid 35 is in the main provided by the electrically operated heating device 50 which is designed as a gas turbine 56 driven by a generator 55 as a motor. For generating heat by means of the generator 55 which is driven as a motor, electric energy from this is converted into mechanical kinetic energy of the gas turbine 56. The absorption of electric energy is represented in the present case as an arrow which is not additionally numbered. By driving the generator 55 as a motor, a compression of the intake air in the compressor stage of the gas turbine 56 is carried out, wherein an essentially adiabatic heating of the compressed air occurs. According to an embodiment, it is also possible, for further increase of the heat content of this compressed air, to burn fuel in the combustion chamber of the gas turbine 56 for additional transfer of heat. If the thus treated compressed air discharges from the gas turbine 56, it has an increased temperature level in comparison to the intake air. By means of a suitable routing of this thermally conditioned air from the gas turbine 56 for the thermal coupling with the accumulator 30, the heat contained in the air can be at least partially transferred to the heat transfer fluid 35 in the accumulator 30. The thermal heat thus contained in the heat transfer fluid 35 is then available for further utilization in the desorber 22.

According to an alternative embodiment, it can also be provided that the gas turbine 56, in regular power generating mode, fulfills the function of the combustion device 10. Only in power consuming mode, i.e. if the generator 55 is driven as a motor, is electric energy converted into thermal energy for heating the accumulator 30.

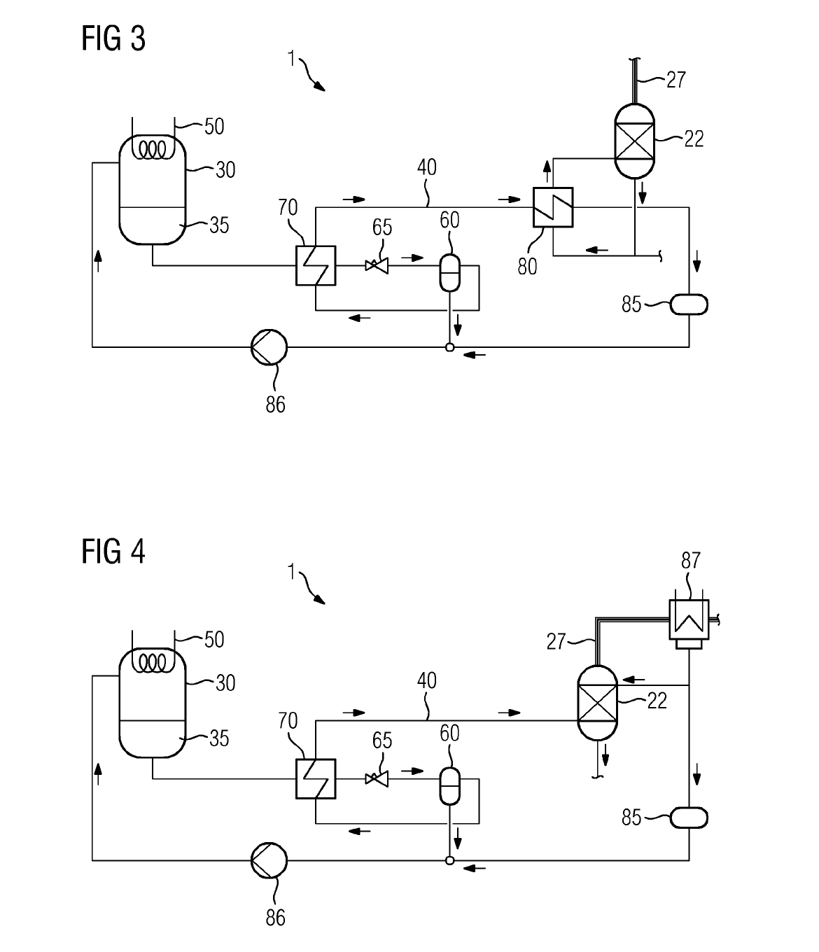

FIG. 3 shows an embodiment, not claimed in the present case, of a device for separating CO₂ from a flue gas flow 11 of a combustion device 10 (not shown in the present case) in a schematic view of connections. Comparable to the embodiment of the invention shown in FIG. 2, an accumulator 30, which has a predetermined quantity of heat transfer fluid 35, is again included. For the thermal conditioning of this heat transfer fluid 35, provision is furthermore made for an electrically operated heating device 50 which in the present case is shown only schematically as a heating coil. By means of this electrically operated heating device 50, electric energy can be converted into thermal energy which can be temporarily stored by the heat transfer fluid 35 in the accumulator 30. When required, heat transfer fluid 35 can be extracted from the accumulator 30 and be fed to an expansion vessel 60 (“flash vessel”).

In this case, it is to be stated that the heat transfer fluid 35 contained in the accumulator 30 is under pressure in a superheated state. After feeding the heat transfer fluid 35 to the expansion vessel 60, a thermal expansion is carried out, resulting in a phase separation of the heat transfer fluid 35. The expansion is achieved in this case by means of an expansion valve 65 which is connected upstream to the expansion vessel 60. During the phase separation, some of the heat transfer fluid 35 is deposited in liquid phase in the bottom region of the expansion vessel 60, wherein the rest of the expansion vessel 60 is occupied by steam (gaseous heat transfer fluid 35) which is fed to the desorber 22.

Before the gaseous proportion of the heat transfer fluid 35 is fed to the desorber 22, a transfer of heat between the gaseous heat transfer fluid 35 and the heat transfer fluid 35 which is to be fed to the expansion vessel 60 is carried out by means of a first heat exchanger 70.

For further transfer of heat from the gaseous heat transfer fluid, a second heat exchanger 80 is included in the piping system 40 and in the sense of a reboiler (see also FIG. 1) also supplies the desorber 22 with thermal energy from the gaseous heat transfer fluid 35. After heat transfer has been carried out, the heat transfer fluid 35 can be condensed out and be made available in a condensate tank 85 for further transmission of fluid. According to the embodiment, the thus condensed heat transfer fluid 35 together with the heat transfer fluid 35 which is condensed out in the expansion vessel 60 is again fed to the accumulator 30 for further thermal treatment. In this case, the application of a flowing movement to the heat transfer fluid can be conducted by a pump 86.

FIG. 4 shows an embodiment, not claimed in the present case, of a device 1 for separating CO₂ from a flue gas flow 11 of a combustion device 10 (not shown in the present case) in a schematic view of connections. The embodiment shown in FIG. 4 differs from the embodiment shown in FIG. 3 only to the effect that the heat transfer fluid 35 which is fed to the desorber 22 does not release its heat to the desorber 22 via a second heat exchanger but by means of a direction injection into the desorber 22. As a result of this, the heat transfer fluid 35 is injected directly into the desorber 22, wherein during the mixing process between heat transfer fluid 35 and solvent contained in the desorber 22 a transfer of heat is carried out at the same time. In order to recover the heat transfer fluid 35, this can be condensed out by means of a condenser 87, for example. Especially in the case in which the heat transfer fluid 35 is water, a mixture of gaseous CO₂ and water is discharged from the desorber 22 via the CO₂ outlet pipe 27 so that the recovery of the water as a result of condensation by means of the condenser 87 can be easily undertaken.

1. A device for separating CO₂ from a flue gas flow of a combustion device, comprising:
a CO₂ separating apparatus having an absorber and a desorber
an accumulator for storing a heat transfer fluid,
wherein the accumulator and the desorber are thermally interconnected via a piping system,
wherein the accumulator is thermally connected to an electrically operated heating device which enables a thermal conditioning of the heat transfer fluid in the accumulator,
wherein the heating device is designed as a gas turbine driven by a generator as a motor, during the driving of which air is drawn into the compression stage of the gas turbine and as a result of the compression is essentially adiabatically heated,
wherein the heated flue gas discharging from the gas turbine interacts with the accumulator for transfer of heat.

2. The device as claimed in claim 1, wherein the heating as a result of compression of the air in the compression stage of the gas turbine is additionally supported by a firing of the gas turbine.

3. The device as claimed in claim 1, wherein the piping system has an expansion vessel which is designed for separating expanded heat transfer fluid into a condensed phase and into a gaseous phase.

4. The device as claimed in claim 3, wherein the piping system has an expansion valve which is connected upstream to the expansion vessel.

5. The device as claimed in claim 3, wherein the piping system has a first heat exchanger which is designed for an exchange of heat between the heat transfer fluid which is fed to the expansion vessel and the gaseous heat transfer fluid which is discharged from the expansion vessel.

6. The device as claimed in claim 3, wherein the piping system has a second heat exchanger which is designed for an exchange of heat between the gaseous heat transfer fluid which is discharged from the expansion vessel and the CO₂-laden solvent of the CO₂ separating apparatus which is fed to the desorber.

7. The device as claimed in claim 1, wherein the piping system opens into the desorber and delivers the heat transfer fluid into the desorber.

8. The device as claimed in claim 1, wherein the piping system is of a cyclic design so that after thermal interaction of the heat transfer fluid with the desorber the heat transfer fluid can be returned to the accumulator again.

9. The device as claimed in claim 3, wherein the piping system is designed in such a way that the condensed phase of the expanded heat transfer fluid can be returned to the accumulator again.

10. The device as claimed in claim 1, wherein the accumulator is a pressure accumulator.

11. The device as claimed in claim 1, wherein the heat transfer fluid is water.

12. A method for operating a device for separating CO₂ from a flue gas flow of a combustion device, comprising a CO₂ separating apparatus, having an absorber and a desorber and an accumulator for storing a heat transfer fluid, wherein the accumulator and the desorber are thermally interconnected, wherein the accumulator is connected to an electrically operated heating device which is designed as a gas turbine driven by a generator as a motor, during the driving of which air is drawn into the compression stage of the gas turbine and as a result of the compression is essentially adiabatically heated, wherein the method comprises:
operating the heating device using electric power, wherein the heated flue gas discharging from the gas turbine interacts with the accumulator for heating the heat transfer fluid in the accumulator; and
heating a solvent of the CO₂ separating apparatus, which is laden with CO₂ and fed to the desorber, by means of the heated heat transfer fluid.

13. The method as claimed in claim 12, further comprising
thermal expansion of the heated heat transfer fluid in an expansion vessel before the heat transfer fluid heats the solvent of the CO₂ separating apparatus which is laden with CO₂ and fed to the desorber.

14. The method as claimed in claim 12, wherein a firing of the gas turbine is carried out for supporting the heating of the compressed air in the compression stage of the gas turbine.
